(19) United States
(12) Patent Application Publication
(10) Pub. No.: US 2021/0040324 A1
(43) Pub. Date: Feb. 11, 2021

(54) DEDUST METHODS AND COMPOSITIONS FOR TREATMENT OF MINERAL FIBERS

(71) Applicant: CARGILL, INCORPORATED, Wayzata, MN (US)

(72) Inventor: Frank P. LOCHEL, Rock Hill, SC (US)

(73) Assignee: CARGILL, INCORPORATED, Wayzata, MN (US)

(21) Appl. No.: 17/041,383

(22) PCT Filed: Apr. 17, 2018
(86) PCT No.: PCT/US2018/027902

§ 371 Date: Sep. 24, 2020

(51) Int. Cl. C08L 91/00; C03C 13/06; C03C 25/255

(52) U.S. Cl. CPC C08L 91/00; C03C 25/255; C03C 13/06

(57) ABSTRACT

Mineral fiber processing is carried out by applying a dedust composition comprising a non-polar, plant-based, bodied oil having an acid value that is less than or equal to about 5 mg KOH/g, an iodine value of 60 to 120, a tan delta ranging from 0.0002 to 0.01 (at 25 C.), and a viscosity of from about 350 cSt to about 750 cSt at 40 C. to mineral fiber. The non-polar, plant-based, bodied oil provides a dedust fluid that is sourced from renewable resources and is surprisingly effective as a dedusting agent in the challenging environment of preparation of bonded mineral fiber-containing products.

### FIELD

The present invention relates to mineral fiber processing and dedust compositions.

### BACKGROUND

Conventional fibers are useful in a variety of bonded fiber-containing products (i.e. products where fibers are bonded together by a binder composition), such as reinforcements, textiles, and acoustical and thermal insulation materials. Various fibers may be used in these products, including glass fibers; organic fibers such as polypropylene, polyester; and multi-component fibers may be used alone or in combination in forming the fiber-containing product. Fiberglass is a composite material comprising glass fibers. Glass fibers are hydrophilic, unless the fibers are modified by a surface treatment. Mineral wool is a composite material comprising mineral fibers. Mineral fibers are compositionally different from glass fibers material, and are also used in the above noted applications. Mineral fibers are made from rock (primarily basalt) and/or slag, and, unless modified by a surface treatment, are hydrophobic. Mineral fibers made from rock are also called “stone fibers.” Specific types of mineral wools include stone wool and slag wool (which are made from stone fiber or slag fiber, respectively).

Dust is often liberated or generated during the formation of products made from glass fibers or from mineral fibers, such as products used for insulation, filtration, soundproofing, and the like. A dedust fluid is often applied to the glass or mineral fibers during the process to reduce this dust. The dust controlling oil remains on the fibers and continues to control dust during transport and installation of the product. Mineral-oil based fluids are often utilized as dedust fluids. In particular, a category of solvent-extracted mineral base oils known as “bright stock” has been used as a dedust composition in stone fiber processing.

The use of polymerized oil as a dust control agent is described in US Patent Application Publication No. 2007/0004811 to Bruner et al.

### SUMMARY

Historically, dedust fluids have been prepared from petroleum sources, and in particular mineral-oil based fluids are often utilized as dedust fluids. It is desirable to identify dedust fluids that are sourced from renewable resources, such as plant-based oils. It has been discovered, however, that plant-based oils that have been used in the past as dedusting agents in preparation of glass fiber products (such as fiberglass insulation) are not suitable for use as dedusting agents in preparation of mineral fiber products (such as mineral wool insulation). It has further been discovered that non-polar plant-based oils have great efficiency in controlling dust from mineral fiber while polar plant-based oils have great efficiency in controlling dust from glass fiber. To this end, a non-polar bodied oil has been developed that is a plant-based bodied oil having an acid value that is less than or equal to about 5 mg KOH/g; an iodine value of 60 to 120; a tan delta ranging from 0.0002 to 0.01 (at 25° C.); and a viscosity of from about 350 cSt to about 750 cSt at 40° C.

In an aspect of the present invention, a method of mineral fiber processing comprises applying a dedust composition comprising a non-polar, plant-based, bodied oil having an acid value that is less than or equal to about 5 mg KOH/g, an iodine value of 60 to 120, a tan delta ranging from 0.0002 to 0.01 (at 25° C.), and a viscosity of from about 350 cSt to about 750 cSt at 40° C. to mineral fibers.

In an aspect of the present invention, a dedust composition for use in mineral fiber processing comprises a non-polar, plant-based, bodied oil having an acid value that is less than or equal to about 5 mg KOH/g, an iodine value of 60 to 120, a tan delta ranging from 0.0002 to 0.01 (at 25° C.), and a viscosity of from about 350 cSt to about 750 cSt at 40° C.

In an aspect of the present invention, a method of producing a non-polar, plant-based, bodied oil, is provided comprising obtaining a starting material plant-based oil selected from a) a plant-based oil that has been blown and b) a plant-based oil that has not been blown; and bodying the obtained plant-based oil to provide a plant-based, bodied oil having: an acid value that is less than or equal to about 5 mg KOH/g, an iodine value of 60 to 120; a tan delta ranging from 0.0002 to 0.01 (at 25° C.), and a viscosity of from about 350 cSt to about 750 cSt at 40° C. In an aspect, a dedust composition suitable for application to mineral fibers is provided comprising the non-polar, plant-based, bodied oil as described herein.

The dedust composition as described herein comprises oils that are sourced from renewable resources. The non-polar, plant-based, bodied oil as described herein is surprisingly effective as a dedusting agent in the challenging environment of preparation of mineral fiber web products (such as mineral wool insulation).

In an aspect, a method of making a bonded mineral fiber-containing product is provided that comprises mixing a dedust composition as described herein with a binder composition to form a binder/dedust mixture; applying the binder/dedust mixture to mineral fibers; collecting and compressing the mineral fibers in the shape of the desired product; and curing the binder, thereby forming the bonded mineral fiber-containing product. In an aspect, the collected and compressed mineral fibers are heated to cure the binder.

In an aspect, a binder/dedust mixture composition for use in making a bonded mineral fiber-containing product comprises a mixture of a) a dedust composition comprising a non-polar, plant-based, bodied oil having an acid value that is less than or equal to about 5 mg KOH/g, an iodine value of 60 to 120, a tan delta ranging from 0.0002 to 0.01 (at 25° C.), and a viscosity of from about 350 cSt to about 750 cSt at 40° C. with b) with a binder composition.

Because the present bodied oils are made using plant-based oils (which are a renewable resource), the present bodied oils are natural in origin and more readily biodegradable.

Certain prior dedust compositions comprise an undesirably high level of low molecular weight components, which leads to volatilization of a portion of the composition during use. The present bodied oils in an aspect exhibit high flash point and in an aspect contain a low amount of volatile organic compound content. As a result, the present bodied oils in an aspect exhibit reduced fire risk, reduced loss of oil to volatilization, exhibit low odor, and provide superior air quality in the manufacturing environment (e.g., manufacturing plants) as compared to mineral-oil based dedust compositions.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

For purposes of the present invention, “Acid Value” is a measure of the residual carboxylic acid groups present in a compound and is reported in units of mg KOH/gram material. The acid number is measured according to the method of AOCS Cd 3d-63.

For purposes of the present invention, “Flash Point” or “Flash Point Temperature” is a measure of the minimum temperature at which a material will initially flash with a brief flame. It is measured according to the method of ASTM D-92 using a Cleveland Open Cup and is reported in degrees Celsius ° C.

For purposes of the present invention, “Iodine Value” (IV) is defined as the number of grams of iodine that will react with 100 grams of material being measured. Iodine value is a measure of the unsaturation (carbon-carbon double bonds and carbon-carbon triple bonds) present in a material. Iodine Value is reported in units of grams iodine (I₂) per 100 grams material and is determined using the procedure of AOCS Cd Id-92.

For purposes of the present invention, “mineral fiber” is fiber made from molten rock, basalt or slag. Sources of mineral fiber include iron slag, limestone, volcanic rock, ceramic, and the like.

For purposes of the present invention, “tan delta” (or tan 6) is a measure of the ratio of resistance to capacitance of the oil, which is also referred to as the dissipation factor. Tan delta is measured by dielectric loss in an insulating fluid according to ASTM D2300, and is a unitless measurement.

For purposes of the present invention, “viscosity” is measured by ASTM D445 using the Cannon Ubbelohde tubes identified in Table 1 of this ASTM. Viscosity is reported in centistokes (“cSt”).

The dedust composition as described herein can in an aspect be prepared by obtaining a starting material oil that is a plant-based oil selected from a) a plant-based oil that has been blown and b) a plant-based oil that has not been blown.

In an aspect of the invention, the starting material plant-based oil is selected from soybean oil, canola oil, rapeseed oil, cottonseed oil, sunflower oil, palm oil, peanut oil, safflower oil, corn oil, safflower oil, corn stillage oil, and mixtures thereof. In an aspect, the plant-based oil is selected from soybean oil, sunflower oil, corn oil, or mixtures thereof. In an aspect, the plant-based oil is sunflower oil. In an aspect, the plant-based oil comprises no more than 5% by weight of any non-plant-based oil; or no more than 3% by weight of any non-plant-based oil; or no more than 1% by weight of any non-plant-based oil. In an aspect, the plant-based oil is free of non-plant-based oil.

In an aspect, the starting material plant-based oil is soybean oil having an iodine value of from about 115 to 145. In an aspect, the starting material plant-based oil is a sunflower oil having an iodine value of from about 120 to 140. In an aspect, the starting material plant-based oil is a corn oil having an iodine value of from about 100 to about 125.

In an aspect, the plant-based oil used as a starting material is a plant-based oil that has been blown. For purposes of the present invention, a blown oil is an oil that has been treated by bubbling air through the oil while heating to temperatures of from about 100° C. to about 130° C. During the blowing process, the oil is polymerized and partially oxidized. In an aspect, the blown oil has a viscosity of from about 150 to about 250 cSt at 40° C. before the blown oil is bodied. In an aspect, the blown oil has a viscosity of from about 180 to about 220 cSt at 40° C. before the blown oil is bodied. Because the final product of the present method is a non-polar oil, if the starting material plant-based oil used is a plant-based oil that has been blown, the plant-based oil should only be “lightly” blown so that the blowing process does not introduce polar groups in an amount such that the final product after the bodying step cannot achieve the required end product tan delta values or the required acid values.

In an aspect, the plant-based oil used as a starting material is a plant-based oil that has not been blown. It has been found that plant-based oils that have not been blown are more easily treated by bodying than blown plant-based oils to provide a final bodied plant based oil having that will exhibit excellent performance properties when used in processes involving mineral fiber materials. While not being bound by theory, it is believed that the unblown plant-based oils are already less polar than blown oils, as shown by initially lower tan delta values, and therefore require less treatment to achieve the desired physical properties for good dedust performance with mineral fiber products.

Additionally, it has been found that when the process of blowing plant-based oils is carried out at temperatures greater than about 115° C., degradation products that have strong odors may be formed. Plant-based oils that have not been blown have been found to be particularly advantageous for use as starting materials in the present method, because they contain fewer odoriferous degradation products that would have to be stripped out in the bodying step.

Conventional plant-based oils, whether blown or not, will not exhibit the physical properties required to be components of effective dedust compositions for mineral fiber product production. It has been found that bodying of the plant-based oil to provide a plant-based, bodied oil having an acid value that is less than or equal to about 5 mg KOH/g, an iodine value of 60 to 120, a tan delta ranging from 0.0002 to 0.01 (at 25° C.), and a viscosity of from about 350 cSt to about 750 cSt at 40° C. provides effective dedust compositions for mineral fiber product production.

In an aspect, the plant-based, bodied oil has an iodine value of from about 60 to about 110, or from about 60 to about 100 or from about 60 to about 90. In an aspect, the plant-based, bodied oil has an iodine value of from about 70 to 110, or from about 70 to about 100 or from about 70 to about 90. In an aspect, the plant-based, bodied oil has an iodine value of from about 80 to 110, or from about 80 to about 100 or from about 80 to about 90.

In an aspect, the starting material plant-based oil is bodied by heating the starting material plant-based oil at a temperature of from about 180° C. to about 330° C. for a time sufficient to achieve the above noted acid value, iodine value, tan delta and viscosity characteristics. In an aspect, the starting material plant-based oil is bodied by heating the starting material plant-based oil at a temperature of from about 180° C. to about 330° C. in the absence of oxygen for a time sufficient to achieve the above noted acid value, iodine value, tan delta and viscosity characteristics

In an aspect, the starting material plant-based oil is bodied by heating the starting material plant-based oil together with at least one hydroxyl-containing organic compound for a time sufficient to provide a plant-based, bodied oil having an acid value that is less than or equal to about 5 mg KOH/g, an iodine value of 80 to 100, a tan delta ranging from 0.0002 to 0.01 (at 25° C.), and a viscosity of from about 350 cSt to about 750 cSt at 40° C. The hydroxyl-containing organic compound reacts with available acid functionalities in the oil to esterify the acid, thereby reducing the observed acid value of the oil and additionally reducing the observed tan delta value of the oil. Bodying together with at least one hydroxyl-containing organic compound is particularly advantageous when the starting material plant-based oil is an oil that has been blown.

In an aspect, the least one hydroxyl-containing organic compound is a hydroxyalkyl compound where the alkyl group is straight, branched or cyclic, and is saturated or unsaturated. In an aspect, the least one hydroxyl-containing organic compound is a hydroxyalkyl compound selected from the group consisting of C1-30 alkyl where the alkyl group is straight, branched or cyclic, and is saturated or unsaturated.

In an aspect, the least one hydroxyl-containing organic compound is a polyol is selected from compounds comprising two hydroxy functionalities. In an aspect, the polyol is selected from compounds comprising three hydroxy functionalities. In an aspect, the polyol is selected from compounds comprising four hydroxy functionalities. In an aspect, the polyol is selected from compounds comprising from five to eight hydroxy functionalities. In an aspect, the polyol is selected from the group consisting of 1,3-propanediol; 1,3-butanediol; 1,4-butanediol; 1,2-hexanediol; 1,6-hexanediol; neopentyl glycol; trimethylolpropane; penta-erythritol; 2,2,4-trimethylpentane-1,3-diol; glycerol; 3(4), 8(9)-dihydroxymethyltricyclo[5.2.1.02,6]decane; 1,2,3-Trihydroxypropane (i.e. glycerol), trihydroxy polyglycerol, isosorbide and dipentaerythritol. In an aspect, the polyol is neopentyl glycol. In an aspect, the polyol is pentaerythritol. In an aspect, the polyol is a mixture of two or more different polyols. In an aspect, at least about 95%, or at least about 99% of the polyol by weight is a single polyol.

In an aspect, the least one hydroxyl-containing organic compound is a polyol. In an aspect, the least one hydroxyl-containing organic compound comprises glycerol. In an aspect, the starting material plant-based oil is treated with from about 0.5 to about 4 wt % glycerol before or during bodying. In an aspect, the starting material plant-based oil is treated with from about 1 to about 3 wt % glycerol before or during bodying.

In an aspect, the starting material plant-based oil is bodied by heating the starting material plant-based oil in the presence of an inert atmosphere. In an aspect, the starting material plant-based oil is bodied by heating the starting material plant-based oil in the presence of nitrogen gas.

In an aspect, the starting material plant-based oil is bodied by heating the starting material plant-based oil in the presence of an inert atmosphere to a temperature greater than 150° C.

In an aspect, the bodying step is carried out at ambient pressure. For purposes of the present invention, “ambient pressure” means that the reactants during the relevant reaction step are not subjected to vacuum or enhanced pressure. In an aspect, the bodying step is carried out in a vacuum of from about 30 to about 50 mmHg. It has been found that carrying out the bodying step under vacuum acts to remove undesirable low molecular weight molecules.

In an aspect, plant-based oils containing odoriferous degradation products are bodied at a temperature sufficiently high to strip the degradation products from the oils, thereby lowering the content of the degradation products in the oils to a non-objectionable level. In an aspect, the bodied plant based oils comprise less than 2 ppm aldehydes.

In an aspect, the plant-based, bodied oil has an acid value of from about 0 to about 5 mg KOH/g. In an aspect, the plant-based, bodied oil has an acid value of from about 0 to about 4 mg KOH/g.

In an aspect, the plant-based, bodied oil has an iodine value of from about 60 to about 120. In an aspect, the plant-based, bodied oil has an iodine value of from about 70 to 110. In an aspect, the plant-based, bodied oil is a soybean oil having an iodine value of from about 80 to 100. In an aspect, the plant-based, bodied oil is a sunflower oil having an iodine value of from about 80 to 100. In an aspect, the plant-based, bodied oil is a corn oil having an iodine value of from about 95 to about 120.

In an aspect, the plant-based, bodied oil has a tan delta of from about 0.0001 to 0.01 (at 25° C.). In an aspect, the plant-based, bodied oil has a tan delta of from about 0.0001 to 0.0006 (at 25° C.). In an aspect, the plant-based, bodied oil has a tan delta of from about 0.001 to 0.006 (at 25° C.). In an aspect, the plant-based, bodied oil has a tan delta of from about 0.003 to 0.01 (at 25° C.).

In an aspect, the plant-based, bodied oil has a tan delta of from about 0.001 to 0.1 (at 90° C.). In an aspect, the plant-based, bodied oil has a tan delta of from about 0.001 to 0.007 (at 90° C.). In an aspect, the plant-based, bodied oil has a tan delta of from about 0.01 to 0.07 (at 90° C.). In an aspect, the plant-based, bodied oil has a tan delta of from about 0.03 to 0.09 (at 90° C.).

In an aspect, the plant-based, bodied oil has a tan delta of from about 0.0001 to 0.01 (at 25° C.) and additionally has a tan delta of from about 0.001 to 0.1 (at 90° C.). In an aspect, the plant-based, bodied oil has a tan delta of from about 0.0001 to 0.01 (at 25° C.) and additionally has a tan delta of from about 0.001 to 0.007 (at 90° C.). In an aspect, the plant-based, bodied oil has a tan delta of from about 0.0001 to 0.01 (at 25° C.) and additionally has a tan delta of from about 0.01 to 0.07 (at 90° C.). In an aspect, the plant-based, bodied oil has a tan delta of from about 0.0001 to 0.01 (at 25° C.) and additionally has a tan delta of from about 0.03 to 0.09 (at 90° C.).

In an aspect, the plant-based, bodied oil has a tan delta of from about 0.0001 to 0.0006 (at 25° C.) and additionally has a tan delta of from about 0.001 to 0.1 (at 90° C.). In an aspect, the plant-based, bodied oil has a tan delta of from about 0.0001 to 0.0006 (at 25° C.) and additionally has a tan delta of from about 0.001 to 0.007 (at 90° C.). In an aspect, the plant-based, bodied oil has a tan delta of from about 0.0001 to 0.0006 (at 25° C.) and additionally has a tan delta of from about 0.01 to 0.07 (at 90° C.). In an aspect, the plant-based, bodied oil has a tan delta of from about 0.0001 to 0.0006 (at 25° C.) and additionally has a tan delta of from about 0.03 to 0.09 (at 90° C.).

In an aspect, the plant-based, bodied oil has a tan delta of from about 0.001 to 0.006 (at 25° C.) and additionally has a tan delta of from about 0.001 to 0.1 (at 90° C.). In an aspect, the plant-based, bodied oil has a tan delta of from about 0.001 to 0.006 (at 25° C.) and additionally has a tan delta of from about 0.001 to 0.007 (at 90° C.). In an aspect, the plant-based, bodied oil has a tan delta of from about 0.001 to 0.006 (at 25° C.) and additionally has a tan delta of from about 0.01 to 0.07 (at 90° C.). In an aspect, the plant-based, bodied oil has a tan delta of from about 0.001 to 0.006 (at 25° C.) and additionally has a tan delta of from about 0.03 to 0.09 (at 90° C.).

In an aspect, the plant-based, bodied oil has a tan delta of from about 0.003 to 0.01 (at 25° C.) and additionally has a tan delta of from about 0.001 to 0.1 (at 90° C.). In an aspect, the plant-based, bodied oil has a tan delta of from about 0.003 to 0.01 (at 25° C.) and additionally has a tan delta of from about 0.001 to 0.007 (at 90° C.). In an aspect, the plant-based, bodied oil has a tan delta of from about 0.003 to 0.01 (at 25° C.) and additionally has a tan delta of from about 0.01 to 0.07 (at 90° C.). In an aspect, the plant-based, bodied oil has a tan delta of from about 0.003 to 0.01 (at 25° C.) and additionally has a tan delta of from about 0.03 to 0.09 (at 90° C.).

In an aspect, the plant-based, bodied oil has a viscosity of from about 350 cSt to about 750 cSt at 40° C. In an aspect, the plant-based, bodied oil has a viscosity of from about 450 cSt to about 750 cSt at 40° C. In an aspect, the plant-based, bodied oil has a viscosity of from about 500 cSt to about 750 cSt at 40° C.

In an aspect, the plant-based, bodied oil has a flash point of at least about 250° C. In an aspect, the plant-based, bodied oil has a flash point of at least 293° C. In an aspect, the plant-based, bodied oil has a flash point of at least 296° C. In an aspect, the plant-based, bodied oil has a flash point of at least 304° C. In an aspect, the plant-based, bodied oil has a flash point of at least 320° C. In an aspect, the plant-based, bodied oil has a flash point of from about 250° C. to about 400° C. In an aspect, the plant-based, bodied oil has a flash point of from about 250° C. to about 325° C. In an aspect, the plant-based, bodied oil has a flash point of from about 290° C. to about 325° C.

In an aspect, the plant-based, bodied oil is a bodied soybean oil having a viscosity of from about 500 to about 600 cSt at 40° C., a Mw of from about 4800 to about 5200, and a Mn of from about 1050 to about 1300 Daltons. In an aspect, the plant-based, bodied oil is a bodied sunflower oil from about 500 to about 600 cSt at 40° C., a Mw of from about 4800 to about 5250, and a Mn of from about 900 to about 1250 Daltons.

In an aspect, the plant-based, bodied oil is a bodied sunflower oil having a viscosity of from about 500 to about 600 cSt, and a flash point from about 295° C. to about 310° C.

In an aspect, the plant-based, bodied oil is a bodied soybean oil having a viscosity of from about 500 to about 600 cSt, and a flash point from about 295° C. to about 310° C.

In an aspect, the plant-based, bodied oil contains less than 3% by weight of compounds having a molecular weight less than or equal to 1000 Daltons. In an aspect, the dedust composition comprising the plant-based, bodied oil contains less than 1% by weight of compounds having a molecular weight less than or equal to 1000 Daltons. In an aspect, the dedust composition comprising the plant-based, bodied oil contains less than 0.5% by weight of compounds having a molecular weight less than or equal to 1000 Daltons. In an aspect, the dedust composition comprising the plant-based, bodied oil contains less than 0.001% by weight of compounds having a molecular weight less than or equal to 1000 Daltons.

The non-polar, plant-based, bodied oil is formulated into a dedust composition suitable for application to mineral fibers. In an aspect, the dedust composition may be applied in an oil-based solution comprising the non-polar, plant-based, bodied oil, or as a neat non-polar, plant-based, bodied oil to the fibers. In an aspect, the dedust composition may be applied in the form of an oil in water emulsion comprising the non-polar, plant-based, bodied oil.

In an aspect, the plant-based, bodied oil is provided as a pre-emulsion composition comprising the non-polar, plant-based, bodied oil in combination with emulsifiers, ready for addition of water.

If the dedust composition is in the form of an oil in water emulsion, then preferably at least one emulsifying component is utilized to form the oil in water emulsion comprising the non-polar, plant-based, bodied oil.

If the dedust composition is in the form of an oil in water emulsion, then in an aspect at least one emulsifying component is utilized to form the oil in water emulsion. The emulsion typically is formed by vigorously agitating the water and the oil in the presence of the at least one emulsifying component. Examples of apparatus that can be utilized to effectively used to form the oil in water emulsion include high shear mechanical devices/mixers, ultrasonic devices, and other equipment/devices known to those of skill in the art for use in forming oil in water emulsions. The weight ratio of the at least one emulsifying components to non-polar, bodied plant-based oil is from 1:200 to 15:100, for example from 1:200 to 5:100, from 1:200 to 3:100 by weight.

Typically, excluding the weight of any water present in the dedust composition, the dedust composition is present in a cured mineral wool insulation product of the invention at a weight percent of from about 0.1 to about 5% by weight of mineral fiber present (for example, from about 0.5 to about 4.0%, or from about 0.5% to about 3.0% by weight (and in some instances from 0.6% to 1.5% by weight) of the mineral fiber present). Excluding the weight of water, the weight ratio of the dedust composition to the solids of the aqueous curable binder composition is from about 1/100 to 34/100, for example from about 6/100 to 13/100, from about 4/100 to 10/100.

In one aspect the at least one emulsifying component comprises a single emulsifier that is utilized to form the emulsion. In this aspect, the emulsifier typically is mixed into the non-polar, bodied plant-based oil before water is introduced to form the emulsion. Examples of emulsifiers that can be utilized include, for example, ionic emulsifiers, non-ionic emulsifiers and mixtures thereof. To minimize competing reactions between the emulsifier and the components of the aqueous curable binder composition, non-ionic emulsifiers preferably are utilized. Examples of non-ionic emulsifiers include: alkoxylated alcohols and alkoxylated fatty acids. Examples of ionic emulsifiers include amine-based emulsifiers (i.e. primary, secondary, tertiary, and quaternary amine-based emulsifiers). Preferably ethoxylated alcohols and ethoxylated fatty acids are utilized. Most preferably, ethoxylated alcohols are utilized.

In another aspect, the at least one emulsifying component comprises a first emulsifying component that is blended into the non-polar, bodied plant-based oil, and a second emulsifying component that is blended into the water that is utilized to form the oil in water emulsion with the oil. Preferably, in this aspect the first emulsifying component and the second emulsifying component are mixed into the oil and water respectively before the oil and water are mixed together to form the oil in water emulsion.

Examples of compounds that may be used for the first emulsifying component include the emulsifiers listed above. Examples of compounds that may be used for the second emulsifying component include: carboxymethylcellulose; maltodextrin; carbohydrates; polyols; natural viscosifiers, such as, xanthan gum, guar gum, schleroglucan; and mixtures thereof. Preferably, the second emulsifying component will increase the viscosity of the water and assist the formation of the oil in water emulsion and enhance the long term stability of the oil in water emulsion. For example, preferably the second emulsifying component will provide an aqueous-based solution having a viscosity of from 15 to 35 centipoise at 25° C., for example from 17 to 33 centipoise at 25° C., preferably from 18 to 25 centipoise at 25° C. for an aqueous solution containing less than 1 percent by weight of the second emulsifying component, preferably less than 0.5 percent by weight (for example less than 0.3 percent by weight) of the second emulsifying component. For stability, in some aspects, the oil in water emulsion will be stable for at least 4 hours, more preferably at least 14 hours and in some instances at least 24 hours (for example, at least 48 hours, 72, hours, 96, hours, or 120 hours. Where long term stability is particularly important, the oil in water emulsion will be stable for at least one week, and in some instances at least two weeks (for example, at least three weeks). Preferably the second emulsifying component comprises carboxymethylcellulose.

In an aspect, the dedust composition as described above may be used as part of a system for manufacture of any bonded mineral fiber-containing products. In an aspect the dedust composition is used as part of a system for manufacture of a bonded mineral fiber-containing product selected from the group consisting of reinforcement material, textiles, acoustical insulation material, and thermal insulation material.

The dedust composition typically is applied concurrently to the fibers with a curable binder composition. In an aspect, the dedust composition is applied concurrently to the fibers with an aqueous curable binder composition.

In an aspect, the system for manufacture of any bonded mineral fiber-containing products comprises a dedust composition as described herein and a binder composition.

In an aspect, the binder composition to be used with the dedust composition in the system is a petroleum-based binder system comprising an aqueous curable binder composition.

In an aspect, the binder composition to be used with the dedust composition in the system is a bio-based binder system comprising an aqueous curable binder composition. In an aspect, the aqueous curable binder composition comprises (i) at least one carbohydrate, for example maltodextrin, having a dextrose equivalent number from 2 to 20; and (ii) at least one crosslinking agent, for example citric acid. In an aspect, the binder compositions are those described in United States Patent Application Publication No. 2014/0083328, titled “BIO-BASED BINDER SYSTEMS,” the disclosure of which is incorporated herein by reference.

In an aspect, a binder/dedust mixture composition for use in making a bonded mineral fiber-containing product comprises a mixture of a) a dedust composition comprising any of the non-polar, plant-based, bodied oils as described herein with b) with a binder composition. It has been found that dedust compositions comprising any of the non-polar, plant-based, bodied oils as described herein can be formulated with a binder composition to provide a compatible composition, so that the resulting binder/dedust mixture composition may be effectively applied to mineral fibers under ordinary conditions of use in preparation of bonded mineral fiber-containing products.

In an aspect, a method of making a bonded mineral fiber-containing product comprises mixing a dedust composition as described above with a binder composition to form a binder/dedust mixture, and applying the binder/dedust mixture to mineral fibers. The binder/dedust mixture can be applied to the mineral fibers before or during product formation in any suitable manner, such as by spraying. The mineral fibers are collected and compressed in the shape of the desired product, such as a non-woven mineral wool mat, and heated to cure the binder. In an aspect, heating is carried out in an oven. In an aspect, heating is carried out in a hot mold to form the desired end product. The applied heat causes the binder to cure, thereby binding the mineral fibers together at sites where they overlap. Through the curing of the binder in this manner, the bonded mineral fiber-containing product is formed. The cured binder imparts strength and resiliency to the mineral fiber product, allowing the fibers to retain their shape.

### EXAMPLES

### Bodied Oils are Prepared as Follows:

Step 1. Blowing the Oil.

Vegetable oil is oxidized by heating at 115° C. in a vessel with an air sparge. The air is blown air into the oil until the oil viscosity reached 200 cSt as measured at 40° C.

Step 2. Bodying the Oil.

The oil from Step 1 is transferred to a high temperature reactor and heated to a temperature of about 230° C. under nitrogen. Heating is stopped, and the reactor is cooled when oil has reached approximately 440 cSt as measured @ 40° C., the acid value of the oil is less than 5.0, and the flash point is greater than 304° C.

The tan delta values of oils prepared according to this methodology was evaluated and compared to that of bright stock mineral oil. All oils as reported had a viscosity of 500 cSt at 40° C. Results are shown in Table 1.

TABLE 1

| | | Blown/not | | |
|---|---|---|---|---|
| | Bright Stock | bodied | | |
| | America's | Vegetable | Bodied | Bodied |
| | Core 2500 | Oil | Soybean | Sunflower |
| | (comparative | (comparative | Oil | Oil |
| Product | example) | example) | (not blown) | (not blown) |
| Expected | Hydrophobic | Hydrophilic | Hydrophobic | Hydrophobic |
| Polar | | | | |
| Character | | | | |
| Tan D at | 0.00029 | 1.411 | 0.00311 | 0.00658 |
| 25° C. | | | | |
| Tan D at | 0.00432 | 7.196 | 0.0406 | 0.0633 |
| 90° C. | | | | |

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1.-17. (canceled)

18. A method of producing a non-polar, plant-based, bodied oil, comprising:
obtaining a starting material plant-based oil selected from a) a plant-based oil that has been blown and b) a plant-based oil that has not been blown;
bodying the obtained plant-based oil to provide a plant-based, bodied oil having:
an acid value that is less than or equal to about 5 mg KOH/g,
an iodine value of 60 to 120,
a tan delta ranging from 0.0002 to 0.01 (at 25° C.), and
a viscosity of from about 350 cSt to about 750 cSt at 40° C.

19. The method of claim 18, wherein the starting material plant-based oil is treated with from about 0.5 to about 4 wt % glycerol before or during bodying.

20. The method of claim 18, wherein bodying of the starting material plant-based oil is carried out at a temperature of from about 180° C. to about 330° C.

21. A binder/dedust mixture composition for use in making a bonded mineral fiber-containing product comprising a mixture of
a) a non-polar, plant-based, bodied oil having:
an acid value that is less than or equal to about 5 mg KOH/g,
an iodine value of 60 to 120,
a tan delta ranging from 0.0002 to 0.01 (at 25° C.), and
a viscosity of from about 350 cSt to about 750 cSt at 40° C.; and
b) a binder composition.

22. The binder/dedust mixture composition of claim 21, wherein the composition is an emulsion.
